(19) United States
(12) Patent Application Publication
(10) Pub. No.: US 2012/0153529 A1
(43) Pub. Date: Jun. 21, 2012

(54) Method for Producing Planar Products from Silicone Rubber

(76) Inventors: Jens Storre, Norten-Hadenberg (DE); Thomas Wurm, Moringen (DE)

(21) Appl. No.: 13/408,154

(22) Filed: Feb. 29, 2012

Related U.S. Application Data
(63) Continuation of application No. PCT/EP2010/063585, filed on Sep. 16, 2010.

(30) Foreign Application Priority Data
Oct. 21, 2010 (DE) 10 2009 044 299.5

(51) Int. Cl. B29C 67/20

(52) U.S. Cl. 264/175

(57) ABSTRACT

The invention relates to a method for producing planar products from silicone rubber having a porous structure. For simplified processing and a uniform pore structure, the method is characterized in that a microbead/silicone oil mixture made of microbeads and silicone oil in a weight ratio of 10:1 to 1:10 is produced, a silicone rubber mixture having the customary mixture components is produced, the microbead/silicone oil is mixed into the silicone rubber mixture on a roller, the silicone rubber mixture is calendered into webs and the webs are vulcanized.

### CROSS REFERENCE TO RELATED APPLICATIONS

This application is a continuation application of international patent application PCT/EP 2010/063585, filed Sep. 16, 2010, designating the United States and claiming priority from German application 10 2009 044 299.5, filed Oct. 21, 2009, and the entire content of both applications is incorporated herein by reference.

### FIELD OF THE INVENTION

The disclosure relates to a process for producing sheet products made of silicone rubber with porous structure.

The expression “silicone rubber with porous structure” covers systems which have been foamed or are porous. The cells of this porous structure can be closed cells and/or open cells.

Porous rubber structures are usually produced by using blowing agents which have optionally been encapsulated in microbeads and which are metered into the rubber mixture in the unvulcanized state, and which liberate gases on heating, e.g. during the vulcanization process. The vulcanization process fixes the resultant inclusions within the rubber.

### BACKGROUND OF THE INVENTION

The use of microbeads for producing rubber or plastics material with porous structure is known. The microbeads have diameters in the pm range. Blowing agent is charged to hollow, expandable microbeads (microspheres) made of glass, of phenolic resin, of carbon, or of thermoplastic material, and the microbeads expand on heating. The resultant material is used by way of example for antislip coatings, carpet-backing material, or printing inks with three-dimensional effects. An advantage of the expandable microbeads in comparison with conventional chemical blowing agents in PVC or in other thermoplastics is that they foam in a controlled manner at low temperatures, generate a homogeneous cell structure, and provide a relatively wide range of time/temperature within which foaming proceeds without collapse of cell structure. Microbeads of this type are marketed by way of example by Akzo Nobel as Expancel®.

Preexpanded microbeads are used as lightweight fillers for weight reduction in, for example, insulation material and paint. There are often also resultant advantages with regard to the acoustic properties of the material produced.

The abovementioned properties of microbeads have already been utilized in the field of rubber technology. In this context, U.S. patent application publication 2003/0035941 discloses a foamed rubber material for acoustic decoupling, or in the form of damping material for marine applications. Microbeads made of thermoplastic material, which have not been preexpanded, are incorporated here into various rubber mixtures by mixing under non-aggressive conditions. The microbeads then expand during the heating and vulcanization process and form a foam structure.

U.S. Pat. No. 3,700,541 proposes microbeads for use in the compressible layer of rubber printing blankets. Hollow, thermoplastic microbeads can be used here either in preexpanded form or in expandable form. A process which is often utilized for introducing the microbeads into the rubber polymer and which is proposed in U.S. Pat. No. 3,700,541 consists in dispersing the microbeads in a rubber mixture solution made of rubber mixture and of organic solvent. The rubber mixture solution is then poured or distributed (doctor blade method) to give a layer of desired thickness, dried, and vulcanized. The solution here can be poured directly onto other layers of the printing blanket or distributed thereon, for example on a reinforcement layer made of a textile. The process involves solvent and is therefore hazardous to the environment. It is moreover energy-intensive and expensive because a rubber mixture solution first has to be produced and the solvent in turn has to be driven off after the distribution process and prior to the vulcanization process.

JP 61243836 A describes a silicone rubber roll, the silicone rubber layer of which was produced by mixing silicone rubber with from 0.1 to 30% by weight of expandable microbeads comprising a volatile substance, and from 1 to 50% by weight of silicone oil, and then heating to from 80 to 200° C. in a cylindrical roll mold to expand the microbeads and crosslink the silicone rubber. No sheet products are described.

When the microbeads, which have very low density, are incorporated by mixing into rubber mixtures, process technology problems arise because the microbeads generate large amounts of dust and become electro-statically charged. This poses problems particularly when rubber mixtures are processed on a roll mill. The microbead material is difficult to handle. In addition, when the microbeads are incorporated by mixing on a roll, uniform distribution of the microbeads in the mixture is often difficult to achieve, requiring lengthy processing. Another possible result of the lengthy processing with exposure to shear forces is a destruction of the microbeads, in particular of the preexpanded microbeads, which then fail to form a foam structure in the product. If insufficient mixing is carried out, the foam structure obtained in the rubber is not uniform.

### SUMMARY OF THE INVENTION

The disclosure is therefore based on the objective of providing a process which can produce sheet products made of silicone rubber with a porous structure and which mitigates the process technology problems, and achieves a uniform pore structure.

According to the disclosure, the objective is achieved in that, in the process,

a microbead-silicone-oil mixture made of microbeads and silicone oil in a ratio by weight of from 10:1 to 1:10 is produced,

a silicone rubber mixture is produced with conventional mixture constituents,

the microbead-silicone-oil mixture is incorporated into the silicone rubber mixture by mixing on a roll,

the silicone rubber mixture is calendered to give webs, and

the webs are vulcanized.

It has been found that the prior mixing of the microbeads with a silicone oil in the given ratio is successful in binding the dusty microbead material and in incorporating it rapidly and uniformly into the silicone rubber mixture on a roll. The roll-milled mixture can be efficiently calendered to give webs which can then be vulcanized, e.g. in a tank or by way of a continuous rotary vulcanization process. This method can be used to obtain sheet products, i.e. web material, made of silicone rubber with a uniform porous structure and with a density of from 0.1 to 1.1 g/cm³.

Another finding when the process according to the disclosure was used was that there is no destruction of the microbeads, in particular preexpanded microbeads, during processing of the mixture on the roll mill or during the calendering process. It is believed that the silicone oil forms a protective layer around the microbeads, thus minimizing friction when the surrounding rubber material moves past the microbeads.

The ratio by weight of microbeads to silicone oil in the process according to the invention is from 10:1 to 1:10, preferably from 5:1 to 1:5. If ratios using more microbeads are selected, the material generates very large amounts of dust during processing. Another phenomenon that can sometimes occur is destruction of some of the microbeads during the incorporation-by-mixing process. If the ratio of microbeads to silicone oil is set to a value greater than 1:10, the mixture separates. The system thus loses its homogeneous property, and the silicone oil content causes excessive impairment of the properties of the silicone rubber mixture.

The microbead-plasticizer mixture can be produced with the aid of conventional fluid mixers or by using a paddle agitator. There is no need here for addition of other auxiliaries.

In order to achieve faster and better mixing of the microbeads with the silicone oil, it has however proven advantageous that, prior to mixing with the microbeads, the silicone oil is mixed with an organic solvent in a ratio by weight of from 5:1 to 1:20, and the solvent is in turn removed prior to introduction into the silicone rubber mixture. The result is optimization of the surface tension of the silicone oil and at the same time lowering of its viscosity. The wetting and incorporation-by-mixing of the microbeads can thus be better achieved. Solvents that can be used are any of the familiar organic solvents. It is preferable to use solvents which have a low boiling point, in order that they can in turn be removed without high energy cost. This can be achieved by way of example in the case of a paddle agitator by then applying a vacuum with the aid of a vacuum pump with cold trap. The solvent can then be reused. Solvent used preferably comprises isopropanol, which is a solvent with low boiling point that is not hazardous to the environment.

The hollow microbeads used in the process according to the disclosure can involve microbeads made of glass, of thermoplastic material, of phenolic resin, or of carbon. However, it is preferable to use microbeads made of glass or of thermoplastic material. The latter have a certain elasticity and are more capable of withstanding the shear forces in a rubber mixture.

According to the disclosure, the vulcanization process can use expandable microbeads which comprise blowing agent. These are less easily damaged by exposure to shear forces. These microbeads expand during vulcanization of the web and thus form a pore structure in the silicone rubber.

According to one preferred embodiment of the disclosure, the microbeads involve hollow, preexpanded microbeads with a size of from 5 to 100 pm. When these preexpanded microbeads are used, a particularly uniform foam structure or pore structure is obtained because the beads have been expanded in advance, and do not react differently to different regions of temperature and of pressure during the vulcanization process, and therefore no differences in pore diameter arise in the rubber during the expansion process.

After the rubber mixture has been calendered to give webs, the vulcanization process takes place. This vulcanization process can involve molds, tanks, pressurized steam, or rotary vulcanization processes.

It is particularly preferable that the process uses hollow, preexpanded microbeads with a size of from 5 to 100 μm, and that the web obtained after the calendering process is vulcanized continuously by way of a rotary vulcanization process, e.g. what is known as the AUMA process. In the continuous rotary vulcanization process, which is particularly suitable for web material, the web of rubber mixture is forced by means of steel belt or rubber-covered link conveyor onto a rotatable and heatable drum. By using the process according to the disclosure and by using preexpanded microbeads in the rotary vulcanization process it is possible to achieve a particularly uniform pore structure and a uniform thickness of the web across the entire width. This can be explained by the fact that the web of rubber mixture has the desired thickness prior to the vulcanization process, and nonuniform conditions of temperature and of pressure in the vulcanization system have hardly any effect on the thickness of the material.

Different amounts of microbeads can be metered into the silicone rubber mixture. In order to avoid excessive dryness of the mixture and to obtain good product properties from the vulcanized mixture, it has proven advantageous that the silicone rubber mixture comprises from 0.5 to 20% by weight of microbeads.

According to another advantageous embodiment of the disclosure, the microbead-silicone-oil mixture is added to the mixture at the conclusion of the mixing process after all of the other ingredients, such as fillers, antioxidants, vulcanization chemicals, etc., have been metered into the silicone rubber mixture. This method can further reduce the exposure of the microbeads to mechanical load.

The webs produced by the process according to the disclosure, made of silicone rubber with porous structure and density of from 0.1 to 1.1 g/cm³, can be used for a very wide variety of purposes where there is need for a flexible and/or rubbery property in combination with, for example, thermal insulation (diving suits or heat-resistant clothing, etc.). For these purposes, another possibility is that, prior to the vulcanization process, the webs are covered with further layers of textile and/or of rubber mixture.

### DESCRIPTION OF THE PREFERRED EMBODIMENTS OF THE INVENTION

The disclosure will be explained in more detail by using a working example, but without any resultant restriction thereto.

A rubber mixture based on silicone rubber was produced with 1.2% by weight of hollow expanded microbeads (Expancel® microspheres DE 40 from Akzo Nobel).

According to a first variant of the process, this was achieved by mixing 350 silicone oil from Basildon Chemicals,

England with microbeads (Expancel® DE 40 microspheres from Akzo Nobel) in a ratio by weight of 1:1 in a paddle mixer. Mixing time was about 60 min.

According to a second variant of the process, a 350 silicone oil from Basildon Chemicals, England was first mixed with isopropanol in a ratio by weight of 1:5. The microbeads (Expancel® microspheres DE 40 from Akzo Nobel) were then mixed with the abovementioned mixture of silicone oil and isopropanol in a ratio by weight of 1:6 in a paddle mixer. Mixing time was about 20 min. The isopropanol was in turn then removed with application of a vacuum to the paddle mixer. It was collected in a cold trap and can be reused.

The silicone rubber mixture was then produced on a roll mill with the usual additives, such as antioxidants, dyes, and crosslinking agents. At the end of the mixing process, the microbead-silicone-oil mixture produced according to the first or second variant of the process was incorporated by mixing. The mixture was calendered to give webs of thickness from 1 to 4 mm, and then was continuously vulcanized by way of a rotary vulcanization process. The resultant webs had uniform pore structure and uniform thickness across the entire width of 1400 mm, and a plurality of webs were also vulcanized simultaneously together here up to a thickness of 10 mm.

It is understood that the foregoing description is that of the preferred embodiments of the invention and that various changes and modifications may be made thereto without departing from the spirit and scope of the invention as defined in the appended claims.

What is claimed is:

1. A process for producing sheet products made of silicone rubber with porous structure, comprising:
producing a microbead-silicone-oil mixture made of microbeads and silicone oil in a ratio by weight of from 10:1 to 1:10,
producing a silicone rubber mixture with conventional mixture constituents,
incorporating the microbead-silicone-oil mixture into the silicone rubber mixture by mixing on a roll to form a rubber mixture,
calendaring the rubber mixture to give webs, and
vulcanizing the webs.

2. The process as claimed in claim 1, wherein the microbeads are mixed with a silicone oil in a ratio by weight of from 5:1 to 1:5.

3. The process as claimed in claim 1, wherein, prior to mixing with the microbeads, the silicone oil is mixed with an organic solvent in a ratio by weight of from 5:1 to 1:20, and the organic solvent is in turn removed prior to the incorporating into the silicone rubber mixture.

4. The process as claimed in claim 1, wherein the microbeads have a shell made of a thermoplastic material or glass.

5. The process as claimed in claim 1, wherein the microbeads comprise blowing agent and are expandable during the vulcanization process.

6. The process as claimed in claim 1, wherein the microbeads are hollow, preexpanded microbeads with a size of from 5 to 100 μm.

7. The process as claimed in claim 6, wherein the web is vulcanized continuously by way of a rotary vulcanization process (AUMA).

8. The process as claimed in claim 1, wherein the rubber mixture comprises from 0.5 to 20% by weight of microbeads.

9. The process as claimed in claim 3, wherein the organic solvent is isopropanol.
